(19) United States
(12) Patent Application Publication
(10) Pub. No.: US 2016/0006372 A1
(43) Pub. Date: Jan. 7, 2016

(54) DYNAMICALLY-BALANCED FOLDED-BEAM SUSPENSIONS

(71) Applicant: Technion Research & Development Foundation Limited, Haifa (IL)

(72) Inventors: David ELATA, Haifa (IL); Shai SHMULEVICH, Haifa (IL)

(21) Appl. No.: 14/792,915

(22) Filed: Jul. 7, 2015

Related U.S. Application Data
(60) Provisional application No. 62/021,307, filed on Jul. 7, 2014.

(51) Int. Cl. H02N 1/00

(52) U.S. Cl. CPC H02N 1/008

(57) ABSTRACT

It is believed that the folded-beam suspension responds as a linear spring. Though true for the static response, this is not true for dynamic responses. For shuttle displacements in the order of the width of the flexure beams, the response becomes strongly nonlinear. This nonlinearity is caused by axial stresses which are induced due mainly to the inertia of the flying bar. A solution for this problem is given by shortening the anchored beams of the suspension by a predetermined amount, such that the flexure beams between anchor and flying bar, and between flying bar and shuttle have different lengths. In this dynamically-balanced suspension, the ratio between the motions of the shuttle and of the flying-bar ensures that the effective shortening of all beams is the same. Therefore, no axial stresses are induced, and the motion ratio is constant and unaffected by motion amplitude, resulting in a linear dynamic spring response.

### FIELD OF THE INVENTION

The present invention relates to the field of micro-electromechanical systems (MEMS), especially to the construction of folded beam suspensions such as are used for supporting electrostatic comb drives.

### BACKGROUND OF THE INVENTION

Folded-beams are prevalent as suspensions that support electrostatic comb-drives, which are intended to perform as linear springs over a wide range of motions. However, the dynamic response of such prior art folded beam suspensions is known to be linear only in a limited range of extremely small motion. It has been believed up to now that such non-linearity is a result of large deflections or electrostatic forces, but no reliable method or structure has been devised to avoid this non-linearity.

Electrostatic MEMS resonators were first introduced in 1967, and have since found many applications. In the initial work by H. C. Nathanson et al on “The Resonant Gate Transistor,” published in IEEE Transactions on Electron Devices, vol. 14, pp. 117-133, 1967, there was presented an electrostatic resonator based on a gap-closing actuator. However, the response of gap-closing electrostatic actuators is nonlinear and they suffer from pull-in instability. Over the years much progress has been achieved in the design of gap-closing electrostatic resonators, but nonlinearities still affect their performance. Electrostatic resonators with better performance became practical with the introduction of electrostatic comb-drives which were supported by folded-beam suspensions. The static response of such systems has been shown to be linear over a large range of motion, such as is shown in the articles “An Electrostatic actuator with large dynamic range and linear displacement-voltage behavior for a miniature spectrometer,” by C. Marxer, et al, presented at Transducers '99, Sendai, Japan, 1999, “Micromechanical comb actuators with low driving voltage,” by V. Jaecklin et al, published in Journal of Micromechanics and Microengineering, vol. 2, pp. 250, 1992, and “Comb-drive actuators for large displacements,”, by R. Legtenberg et al, published in Journal of Micromechanics and Microengineering, vol. 6, pp. 320-329, 1996.

Folded-beam suspensions are designed to perform as linear springs, but it has been found that, unlike their static characteristic, their dynamic response is nonlinear. This is a serious limitation since a non-linear response means that the resonant frequency of the system incorporating the folded beam suspension is not constant, but is dependent on the amplitude of the vibration. This nonlinear response has been observed for many years, but the reason has not been fully understood. In the literature, this effect has been attributed to electrostatic effects or to large deformations. Recently, it has been suggested that geometrical nonlinearity may also cause a nonlinear response, as discussed in “Dynamic analysis of a micro-resonator driven by electrostatic combs,” by M. T. Song, et al., by D. Q. Cao, et al, as published in Communications in Nonlinear Science and Numerical Simulation, vol. 16, pp. 3425-3442, 2011.

In the article titled “Geometric Stress Compensation for Enhanced Thermal Stability in Micromechanical Resonators” by W. T. Hsu and C. T-C. Nguyen, presented in the 1998 IEEE Ultrasonics Symposium, and published on pages 945-948 of the Proceedings, there is shown a method for compensating for the strong temperature dependence of the resonant frequency of a folded beam micromechanical resonator by constructing the suspension beams to have different lengths. The aim of that work appears to have been to find the correct ratio of beam lengths such that thermal effects would not affect the natural frequency of the resonator. Axial stresses that are induced when motion amplitudes are of the order of the flexure width or larger do not appear to have been considered. Therefore, if a thermally compensated resonator, such as proposed by Hsu and Nguyen, were to resonate with amplitudes of the order of the flexure width or larger, it would presumably respond as a nonlinear spring.

However, other than a general statement that, because of the difference in thermal expansion rates, the long and short beams in the folded flexure experience compressive and tensile stresses respectively, which then influence the resonance frequency ωₒ of the device, no further details are given of how such temperature compensation operates. Furthermore, the mechanism proposed in that publication is only possible if the thermal expansion coefficients of the substrate and the structural material differ. Thus, the proposed mechanism could not be used for a resonator fabricated entirely from a silicon substrate, as is generally done.

The reason for the above mentioned non-linearity in conventional folded suspension resonators has not been convincingly explained, and consequently, methods of overcoming this non-linearity have not been specifically disclosed, such that there therefore still exists a need for a folded beam suspension which overcomes at least some of these disadvantages of prior art suspensions, in particular, that of the non-linearity of its response in dynamic uses.

The disclosures of each of the publications mentioned in this section and in other sections of the specification, are hereby incorporated by reference, each in its entirety.

### SUMMARY

It is shown in this disclosure that there is a fundamental problem with the design of prior art folded-beam suspensions, and that their dynamic response cannot be linear, even when very small vibration motions are considered. The geometrical nonlinearity is shown to be caused by inertial effects which induce axial stress in the beam flexures. Based on this assumption, a new method of constructing a dynamically-balanced folded-beam suspension is given, in which axial stresses are not induced. This is achieved by making the flexure beams used to connect the anchor to the flying bar, and the flying bar to the shuttle, of different lengths. This is in contrast to conventional prior art folded beam suspensions, where the flexure beams intentionally have the same length. A method of calculating the lengths of the flexure beams is shown, as a function of the relative masses of the flying bar and the shuttle. It is shown that, unlike prior art folded-beam suspensions, the dynamic response of this novel folded-beam suspension, is linear.

Experimental data of the dynamic response of a prior art electrostatic resonator shows its nonlinear nature. To reveal the cause of this nonlinearity, analysis of the static response of the standard folded-beam suspension explains why its dynamic response cannot be linear, and that this is unrelated to its electrostatic actuation. A simplified model of the system shows how inertial effects induce axial stresses even in small vibration amplitudes. The new design disclosed in the present application, of a dynamically-balanced folded-beam suspension having flexure beams with different length, such that at resonance no axial stresses are induced, solves this problem. Numerical simulations, in which the damped and undamped dynamic responses of the standard and new dynamically-balanced suspensions are compared, clearly indicate that the nonlinear response of the standard folded-beam suspension is due to inertial effects.

There is thus provided in accordance with an exemplary implementation of the devices and methods described in this disclosure, a folded beam suspension resonator comprising:

(i) a shuttle suspended by a suspension such that its motion is regulated by the elastic characteristics of the suspension,
(ii) a pair of flying bars, one disposed on each side of the shuttle, each flying bar connected to the shuttle by a first pair of flexure beams, and being connected to anchor points by a second pair of flexure beams, the length of each of the second pair of flexure beams being shorter than the length of each of the first pair of flexure beams,
wherein the lengths of the flexure beams in the first and second pairs of flexure beams are selected such that no internal axial stresses are induced in the flexure beams when the resonator is undergoing harmonic motion.

In such a resonator, the lack of internal axial stress may be achieved by selecting the lengths of the flexure beams such that the axial contractions of the first pair of flexure beams are equal to the axial contractions of the second pair of flexure beams. Furthermore, the harmonic motion should have a linear response, such that the stiffness of the suspension is independent of the amplitude of the harmonic motion. In such a case, the linear response should be maintained when the shuttle has an amplitude of motion of more than the width of the flexure beams, the width being defined as being in the plane of motion of the resonator.

Additionally, in such resonators, the lack of internal axial stresses should arise from the elimination of the resultant compression and resultant tension strain stiffening forces within the first and second pairs of flexure beams, due to the harmonic motion.

In any of the above described resonators, the folded beam suspension may be fabricated on a substrate, and the material of the suspension may be essentially the same as that of the substrate.

Yet other implementations perform a method of generating harmonic motion having a linear response in a folded beam suspension resonator, the folded beam suspension comprising a shuttle connected to a pair of flying bars by second pairs of flexure beams, each of the flying bars being connected to anchor points by a first pair of flexure beams, the method comprising selecting different lengths L₁ and L₂ for the flexure beams of the first and second pairs of flexure beams, the ratio between lengths L₁ and L₂ being unknown, wherein the ratio can be determined by:

(i) generating the equations of motion of the shuttle and of each of the flying bars in terms of the known geometrical and material parameters of the elements of the resonator, wherein the amplitude Δ₁ of the edge deflection of a flexure beam of the first pair of flexure beams, generated by motion of a flying bar relative to the anchor, and the amplitude Δ₂ of the edge deflection of a flexure beam of the second pair of flexure beams, generated by motion of the shuttle relative to a flying bar, and the fundamental resonant frequency of the resonator is unknown,
(ii) determining the axial contraction δ₁ and δ₂ of each of the pairs of flexure beams, and
(iii) applying to the equations of motion the additional constraint equation that the axial contractions δ₁ and δ₂ are identical, such that the resonator has a linear response.

In such a method, the resonator may have a linear response when the shuttle has an amplitude of motion of more than the width of the flexure beams, the width being defined as being in the plane of motion of the resonator.

Furthermore, in any of the above described methods, the folded beam suspension may be fabricated on a substrate, and the material of the suspension may then be essentially the same as that of the substrate.

### BRIEF DESCRIPTION OF THE DRAWINGS

The present invention will be understood and appreciated more fully from the following detailed description, taken in conjunction with the drawings in which:

FIG. 1 shows a drawing of the comb-drive resonator with schematics of the experimental setup used to measure its response;

FIG. 2 is a graph showing the measured motion amplitude of a prior art resonator shuttle as a function of excitation frequency, for various levels of excitation voltage;

FIGS. 3A and 3B illustrate schematically a prior art folded-beam suspension in its static unloaded and loaded states; FIG. 3C shows schematic views of the deformed shape of a flexure beam and its mirror image; FIG. 3D shows the folded-beam suspension of FIG. 3A in harmonic dynamic motion;

FIGS. 4A to 4D show two cases of constrained cantilever beams in the undeformed state and deformed state;

FIG. 5 illustrates schematically a model of a folded-beam suspension, being only one quarter section of the full suspension;

FIG. 6 is a schematic representation of the suspension modelled as only a two-mass, two-spring system;

FIG. 7A shows a simplified model of a folded-beam suspension with two beams of different lengths; FIG. 7B illustrates schematically a model of the folded-beam suspension of FIG. 7A, showing only one quarter section of the full suspension;

FIG. 8 is a graph presenting the relative motion ratio α, and the optimal ratio of beam lengths, as a function of the ratio between the masses of the flying-bars and shuttle, for the dynamically balanced suspension of the present disclosure;

FIG. 9 presents the resulting response characteristics during the first 20˜25 vibration cycles for a prior art folded-beam suspension with different values of the shuttle displacement, for different flexure beam widths;

FIG. 10 presents the resulting response characteristics during the first 20˜25 vibration cycles, for a dynamically-balanced suspension of the present disclosure, with different values of shuttle displacement, for different flexure beam widths;

FIGS. 11A and 11B present measured displacement amplitudes for frequency sweeps, with different AC voltage settings; FIG. 11A for prior art suspensions and FIG. 11B for the dynamically-balanced folded-beam suspension of the present disclosure;

FIGS. 12A and 12B show measured velocity and displacement at the frequency of peak response, for small and large motion amplitudes; FIG. 12A for prior art suspensions and FIG. 12B for a device of the present disclosure;

FIGS. 13A and 13B show measured state-space curves at the frequency of peak response, for small and large motion amplitudes; FIG. 13A for a prior art standard folded-beam suspension, and FIG. 13B for a novel dynamically-balanced folded-beam suspension device of the present disclosure;

FIG. 14 shows a model of the dynamic deformation mode of a clamped-flat Euler Bernoulli beam; and

FIG. 15 illustrates the reactive edge force which is necessary for vibrating the clamped-flat beam at any arbitrary frequency.

### DETAILED DESCRIPTION

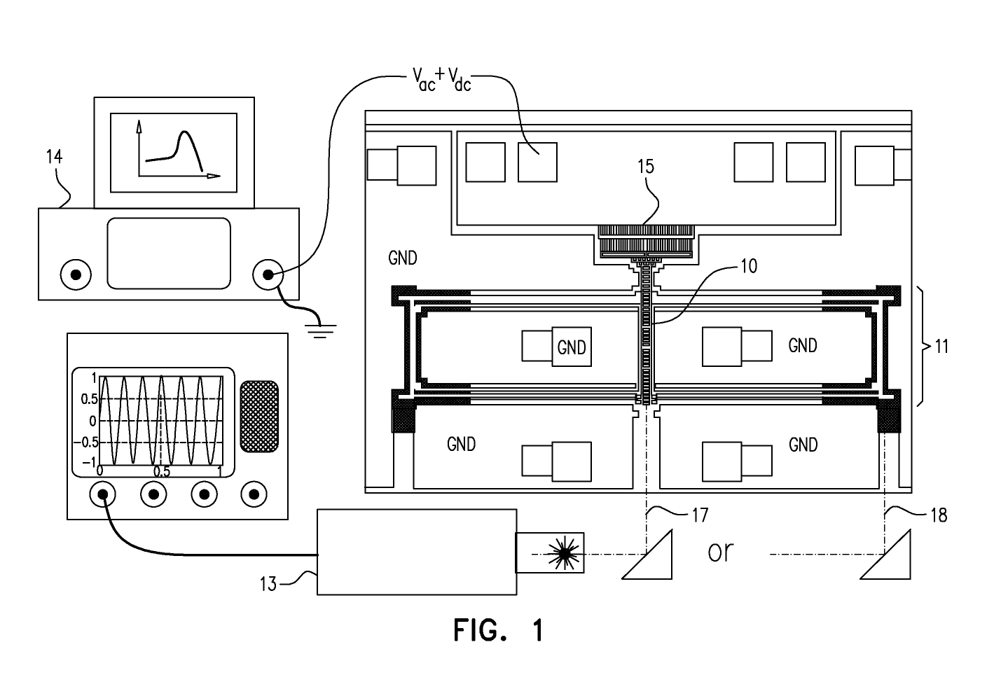

Reference is first made to FIG. 1 which shows a drawing of an exemplary electrostatic comb-drive resonator whose shuttle 10 is supported by a standard folded-beam suspension 11, and showing the schematics of an experimental setup used for verifying the characteristics of the folded beam suspensions, using both prior art designs, and the novel construction methods of the present disclosure. The device shown in FIG. 1 was fabricated using the MEMSCAP Inc. SOIMUMPs (silicon-on insulator micromachining MUMPS® process), with a device layer thickness of t=25 μm. The resonator, including both the resonator shuttle and the folded beam suspension, was fabricated in a (100) single crystalline silicon device layer, and the beams of the flexure are oriented in the (110) direction. The resonator shuttle and folded beam suspension were therefore made essentially of the same material as the substrate, as is cost-effective in the conventional fabrication of such devices. The flexure beams in the suspension are L=600 μm long and h=3 μm wide. The resonator is intentionally designed such that the mass of both flying-bars is equal to the mass of the shuttle.

This resonator is excited by an electric signal V(t)=V_{dc}+V_{ac} sin(ωt) (t=time) with V_{dc}=5 V and various levels of V_{ac} in the range from 30 my to 2.4 V. For each setting of V_{ac}, the excitation frequency is swept over a wide range, and the amplitude of the cyclic motion measured with a Polytec laser vibrometer 13. Separate beam paths 17, 18, of the laser vibrometer measured the motion of the resonator shuttle 11 or of one of the flying bars. A reasonable S/N ratio was achieved by using a lock-in amplifier 14 which provided the reference ac signal to the comb-drive actuator 15, and acquired the signal from the vibrometer with respect to the same ac frequency.

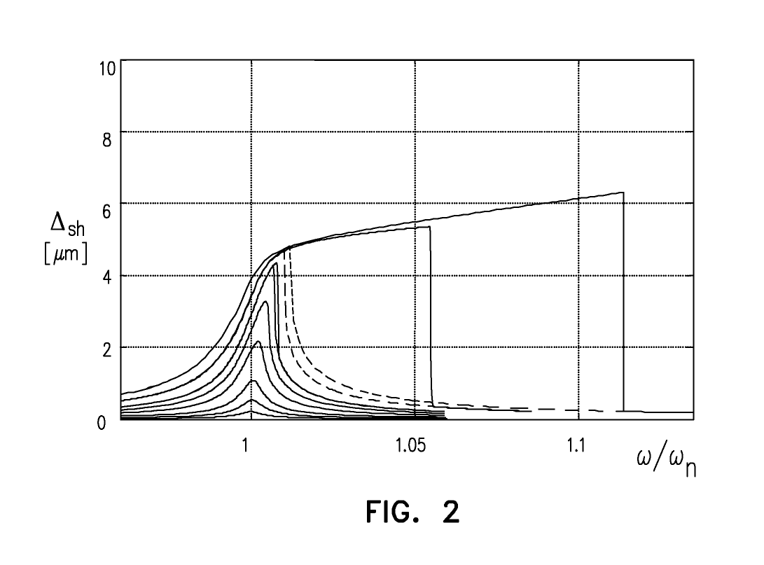

Reference is now made to FIG. 2, which shows the measured motion amplitude Δₛₕ of the resonator shuttle 11 as a function of excitation frequency, for various levels of excitation voltage. The resolution of the frequency sweep is so fine (Δω≈ωₙ/3000) that the measurement points are not marked. The measurements were performed in a vacuum chamber at a pressure of p≈1 Torr such that for small peak motion amplitude, the quality factor was Q≈150. As is observed from the curves of FIG. 2, when the excitation voltage is sufficiently large, which in the example shown, results in a shuttle peak motion amplitude of the order of 4.5 μm, the response branches into two solutions, which required forward frequency sweeps (the solid lines in FIG. 2) and backward sweeps (the dashed lines of FIG. 2). It is also clear from FIG. 2 that for AC voltages which produce a peak motion amplitude of more than approximately 1.5 μm, the response becomes nonlinear. This peak motion amplitude at which non-linearity is noted is very small relative to the length of the flexure beams L=600 μm, but it is close to the thickness of the flexure beams h=3 μm.

It will be shown hereinbelow that this nonlinearity is caused by axial stresses which are induced in the flexure beams due to inertial effects. These axial stresses are similar to those induced in clamped-clamped beams which are subjected to bending. In clamped-clamped beams this effect results in a nonlinear response known as strain stiffening or as membrane stiffening, as described in the article “Extending the travel range of analog-tuned electrostatic actuators” by E. S. Hung et al, published in Journal of Microelectromechanical Systems, vol. 8, pp. 497-505, 1999

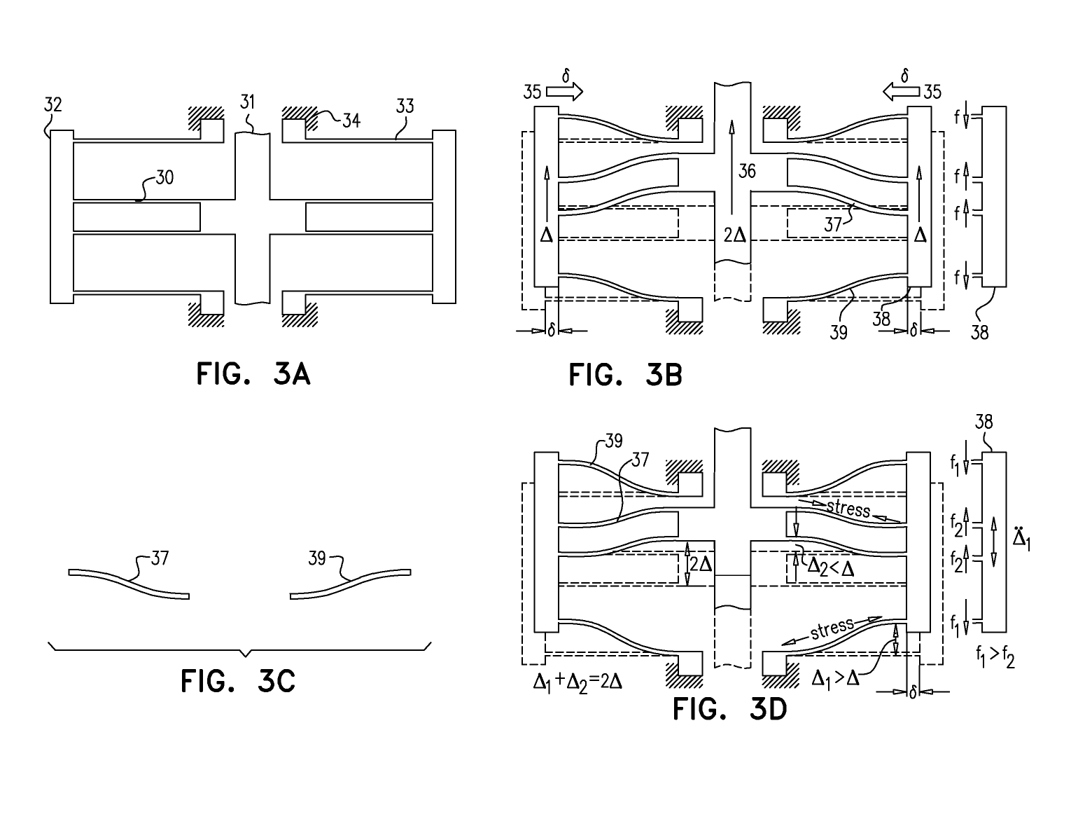

Reference is now made to FIGS. 3A to 3D, which illustrate schematically a conventional prior art folded-beam suspension in its unloaded and loaded states. These figures are used in order to understand the processes taking place in such a prior art folded-beam suspension, including an explanation of the nature of the static response characteristic thereof. This suspension, shown unloaded in FIG. 3A, is constructed from eight flexure beams: four beams 30 connect the shuttle 31 to flying-bars 32, and four other beams 33 connect the flying-bars to fixed anchors 34. The elements are symmetrically arranged on either side of the shuttle 31. In a static loaded state, shown in FIG. 3B, the flexure beams deform, and consequently the flying bars move laterally 35 towards the shuttle, by a distance δ. The primary motion of the shuttle 31 and of the flying-bars 32, both marked by the thin arrows 36, are in the axial direction of the suspension. While the shuttle moves a distance 2Δ, the flying bars move a distance Δ. The slight motion δ by which the flying-bars 32 approach the shuttle 31 is referred to as transverse motion.

The contraction δ between the ends of each beam in a deformed state is referred to as ‘effective shortening’. If the transverse motion of the flying-bars were to be prevented, then the beams would stretch as they bend. The axial stress in the beams due to such stretching would have induced a nonlinear response. This is why the conventional prior art folded-beam suspension is purposely designed with eight identical flexure beams. The intention of using identical beams is that the effective shortening of all beams would be equal, and hence none would develop axial stress.

In such conventional prior art folded-beam suspensions, since all the flexure beams are equal in dimensions, in the static deformed state all beams are bent to a specific shape, shown in FIG. 3C, either to a first deformed shape 37 or to its symmetric image 39, corresponding to the flexure bars marked in FIG. 3B. This mirror imaged configuration applies only to the static deformation case of FIG. 3B.

In static response, the motion 4 of the flying-bar is half that of the shuttle 2Δ. Of the four beams connected to each flying-bar, two beams apply forces in the direction of its axial motion and the other two apply precisely opposite forces. Therefore, each flying-bar is in static equilibrium. This is shown in the representation of the statically displaced flying bar 38 shown on the right hand side of FIG. 3B, with the forces exerted by each of the flexure beams attached thereto shown next to the indication of the flexure beam attachment. Since each of the flexure beams induces an equal force f on the flying bar 38, with the forces of the two flexures attached to the anchors being in the opposite direction to those arising from the flexures attached to the shuttle, the forces on the flying bar cancel identically and their resultant force is zero.

However, if the cyclic motion of the shuttle and flying-bar is considered, if the displacement of the flying-bar is half that of the shuttle, then it must be in static equilibrium. This in turn means that there can be no resultant force that is necessary to accelerate and decelerate the flying-bar through its cyclic motion. If in consequence the displacement of the flying-bar is not half that of the shuttle, then of the four beams connected to each flying-bar, two beams would be in tension and the other two in compression. This is because the deformed shape of the eight beams will not be identical. These axial stresses would necessarily induce a nonlinear response. This is illustrated in FIG. 3D, which is further explained hereinbelow.

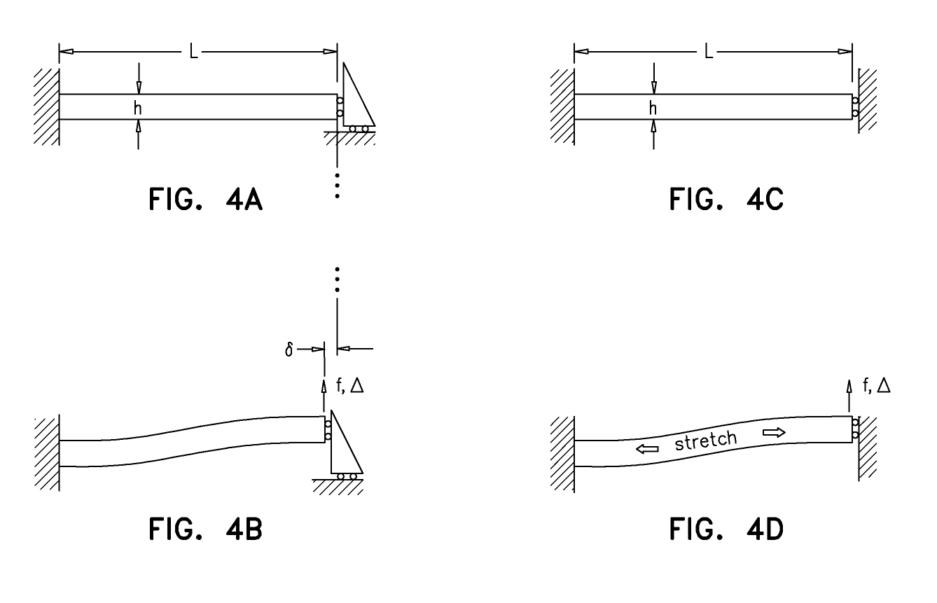

In order to quantitatively characterize the motion of such a conventional prior art folded-beam suspension, reference is first made to FIGS. 4A to 4D, which show two specific cases of the static deformation of a constrained elastic cantilever beam. The beams in both cases are of equal length L. In the clamped-flat beam case of FIGS. 4A and 4B, FIG. 4A showing the undeformed beam and FIG. 4B the deformed beam, the orientation of the end edge of the beam remote from its anchored end is constrained to remain flat, though, as shown in FIG. 4B, this edge may contract axially to relieve axial stress in the beam. In the clamped-guided beam of FIGS. 4C and 4D, both rotation and axial motion of the moving far end edge are constrained.

According to the Euler-Bernoulli beam theory, under application of an edge force f, the clamped-flat beam shown in FIG. 4B will deflect by an amount:

$$Δ = \frac{{fL}^{3}}{12 {E}^{*} I} \qquad ( 1 )$$

Here E* is the effective bending modulus,

$$I = \frac{1}{12} {th}^{3} ,$$

is the second moment of the rectangular cross-section, where h is the beam width and t is the beam thickness (i.e. the device layer thickness). Since practical devices use only wide beams, with t>>h, the effective bending moment, as known, for instance, from the textbook by S. Timoshenko and J. N. Goodier, “Theory of elasticity”, 3rd ed. New York: McGraw-Hill, 1970, is given by:

E*=E/(1−v²) (1a)

where E is the Young modulus and v is the Poisson ratio.

The linear relation between force f and displacement Δ in equation (1) is valid for a wide range of displacements: 0≦Δ≦L/10. For this reason the axial stiffness of the folded-beam suspension is linear so long as the shuttle motion is less than 20% of the length of the flexure beams, as shown in the above cited Legtenberg article.

It can be shown that the axial contraction 6 of the end edge of the clamped-flat beam of FIGS. 4A and 4B, is given by:

$$δ = \frac{3}{5} \frac{{Δ}^{2}}{L} + O ( {Δ}^{4} / {L}^{3} ) \qquad ( 2 )$$

As previously stated, this is referred to as the ‘effective shortening’ of the beam. This is approximately equal to the amount of elongation in the clamped-guided beam of FIGS. 4C and 4D, which is the reason why the clamped-guided beam develops axial tension and responds nonlinearly. For the clamped-guided beam, the deflection follows the same linear relation as in Eq. (1) but only in the very narrow range of 0≦Δ≦h/2. Beyond this edgedeflection range, the axial tension induced in the beam results in a nonlinear response that dominates the linear solution. This effect is sometimes referred to as membrane stiffening or as strain stiffening, and is described for instance, in the above cited “Theory of Elasticity” book, and in the article “Dynamic analysis of a micro-resonator driven by electrostatic combs,” by M. T. Song et al, published in Communications in Nonlinear Science and Numerical Simulation, vol. 16, pp. 3425-3442, 2011.

Returning to the static response of the folded-beam suspension, it can be shown that when the shuttle is statically deflected by a given amount, the flying-bars are deflected in the same direction by half that amount. It also follows that as result of the axial motion of the shuttle, the flying-bars undergo a slight transverse motion towards the shuttle, such that no axial stress is induced in the deflected beams.

The primary motions of the shuttle and the flying-bars, marked by the thin arrows 36 in FIG. 3B, are in the axial direction of the suspension. The slight motion by which the flying-bars approach the shuttle is referred to as transverse motion. A source of potential confusion arises since for the beams of the suspension, the axial and transverse directions are exactly the opposite (i.e. perpendicular) to those of the flying-bars and the shuttle. The terms axial and transverse are therefore used throughout this disclosure in relation to the elements they are referring to.

As shown hereinabove, for the static response case, the motion δ of the flying-bar is half that of the shuttle 2δ. As shown in FIG. 3B, of the four beams connected to each flying-bar 38, two beams apply forces f in the direction of its axial motion and the other two apply precisely oppositely directed forces. Therefore, the flying-bar is in static equilibrium. Now, if dynamic cyclic motion of the shuttle and flying-bar is considered, if the displacement of the flying-bar were to be half that of the shuttle, then the moving system must be in static equilibrium. This in turn would mean that there can be no resultant force acting on moving parts. However, such a resultant force is essential in order to accelerate and decelerate the flying-bar through its cyclic motion, such that this condition cannot be fulfilled for dynamic cyclic motion. Therefore, since for dynamic motion, the displacement of the flying-bar cannot be equal to half that of the shuttle, then of the four beams connected to each flying-bar, two beams must be in tension and the other two in compression. These axial stresses would necessarily induce a nonlinear response, such that it can be stated that the dynamic response of the conventional prior art, symmetrical folded-beam suspension is inherently nonlinear.

Reference is now made back to FIG. 3D, which illustrates this situation of harmonic dynamic motion. In order to accelerate and decelerate the flying-bar 38 in its harmonic motion, the restoring forces f₁, which are applied to it by the anchored flexures 39 must exceed the forces, f₂, applied to it by the shuttle flexures 37, i.e. f₁>f₂. This would occur if the motion amplitude of the flying-bars 38 is more than half the motion of the shuttle. However, in this case the anchored flexures 39 would have been bent more than the shuttle flexures 37, and hence the axial contraction of the anchored beams would have been larger than the axial contraction of the shuttle beams. Since the axial contraction of all beams is constrained by the flying-bars to be the same, it follows that membrane stiffening will be induced. This means that if the harmonic motion amplitude of the shuttle is as large as the flexure width (i.e. if ≧h), then the response of the system will be dominated by the nonlinear membrane stiffening effect.

The novel dynamically-balanced folded-beam suspension disclosed in this application illustrates clearly that the nonlinear dynamic response is indeed caused by an inertial effect. Initially, a simplified model of folded-beams suspensions is presented in which the inertia of the beams is neglected and only the inertia of the shuttle and flying-bars are considered. This approximation enables a simpler explanation of the effect that inertia has on axial stresses in the flexure beams. Numerical simulations of two types of dynamic responses are presented hereinbelow. These simulations support the correct identification of the cause of the nonlinear dynamic response.

Due to the symmetries of the folded-beam suspension, it is simpler to analyze the dynamic response of a quarter of the system shown in FIGS. 3A and 3B. Reference is now made to FIG. 5, which illustrates this model, including only two beams and two masses. The mass m_{fb} represents half of the mass of the flying-bar of a folded-beam suspension, and the mass mₛₕ represents a quarter of the mass of the shuttle. As previously mentioned, each flying-bar has a slight transverse motion, but the displacements and accelerations associated with this motion are insignificant and are therefore ignored.

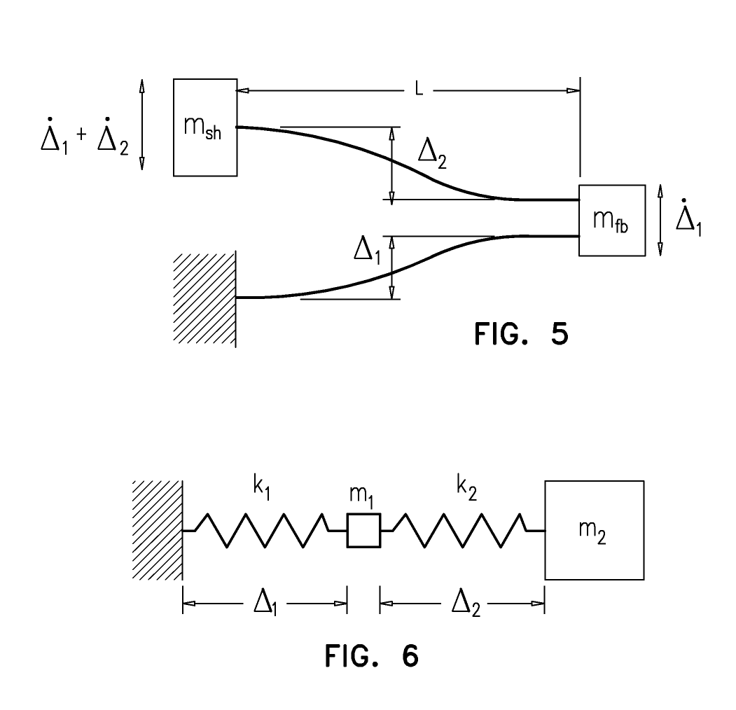

The simplification made is that the inertia of the flexure beams is neglected. Accordingly, the problem may be modelled as only a two-mass, two-spring system, as now shown in FIG. 6. A more rigorous treatment of the problem, taking into account the inertia of the flexure beams, is presented later in this disclosure.

The equations of motion of the system of FIG. 6 are given by:

m₂(\ddot{Δ}₁+\ddot{Δ}₂)=−k₂Δ₂

m₁\ddot{Δ}₁=k₁Δ₁+k₂Δ₂ (3)

where the k are the stiffness coefficients of the springs. Assuming steady vibrations, the motion of the flying-bar and the motion of the shuttle relative to the flying-bar, may be written as

Δ₁=Δα sin(ωt)

Δ₂=Δ sin(ωt) (4)

where α=Δ₁/Δ₂ is the relative motion ratio. Substituting this into (3) yields

$$\begin{matrix}\frac{{m}_{1}}{{m}_{2}} = \frac{1 + α}{α} ( α \frac{{k}_{1}}{{k}_{2}} - 1 ) \\ and & ( 5 ) \\ {ω}^{2} = \frac{{k}_{2}}{{m}_{2}} \frac{1}{1 + α} = \frac{{k}_{1}}{{m}_{1 }} \frac{\frac{{k}_{1}}{{k}_{2 }} - \frac{1}{α}}{\frac{{k}_{1}}{{k}_{2 }}} & ( 6 )\end{matrix}$$

If both beams are of equal length (i.e. k₁/k₂=1), then equations (5) and (6) reduce to

$$\begin{matrix}α = \frac{1}{2} ( \frac{{m}_{1}}{{m}_{2}} \pm \sqrt{{( \frac{{m}_{1}}{{m}_{2}} )}^{2} + 4} ) & ( 7 ) \\ {ω}^{2} = \frac{{k}_{2}}{{m}_{2}} \frac{1}{1 + α} = \frac{{k}_{1}}{{m}_{1 }} \frac{α - 1}{α} & ( 8 )\end{matrix}$$

There are two solutions to equation (7). One solution, α₁, in which the flying-bar vibrates in phase with the shuttle, is positive. The other solution, α₂, in which the masses move in opposite directions—the out-of-phase solution—is negative, and though it is a mathematical solution of equation (7), it has no meaningful physical relevance for the desired motions of the suspension system. The positive solution must be larger than unity, which means that the flying-bar displacement Δ₁ is larger than half the displacement of the shuttle (Δₛₕ=Δ₁+Δ₂).

For example, when m₁/m₂=1, i.e. in the complete suspension, the mass of both flying-bars is equal to the mass of the shuttle, then α₁=GR and α₂=−GR⁻¹, where GR=(1+\sqrt{5})/2 is the golden ratio. The relative motion ratio α=GR is the natural value for the dynamic system, but since the beam lengths are equal, Δ₁≠Δ₂ will necessarily cause differences in the tendency for transverse motion of the flying-bar, as is evident from equation (2). This effect will be marginal if both deflections are smaller than half of the beam width, similar to the response of a clamped-guided beam discussed in the previous section, but will become dominant for Δ₁>h/2.

This means that of the four beams which support each flying-bar, two are in compression and two in tension. These axial stresses increase the stiffness of the suspension. An alternative manner of interpreting this is that whereas α=GR is the natural solution for the dynamic system, for large motions Δ₁>h/2 the motion would tend to be constrained to Δ₁=Δ₂ (as in the static response). This added constraint increases the stiffness of the system. This stiffening and its increase when the vibration amplitude increases, is simulated hereinbelow.

Thus, it is shown that the folded-beam suspension, which is intended to perform as a linear spring, necessarily performs as a nonlinear spring in dynamic responses.

In order to overcome this inherent non-linear dynamic response in the prior art folded-beam suspensions, it is necessary to eliminate the compression and tension strain stiffening forces within the flexure beams of the suspension. According to the novel configurations described in this disclosure, an exemplary folded beam suspension is proposed in which beams of different lengths L₁ and L₂ are used to respectively connect the anchor to the flying bar, and the flying bar to the shuttle. This is in contrast to conventional prior art folded beam suspensions, where the flexure beams have the same length. These different length flexure beams are the key to achieving the dynamically balanced suspension described in the present disclosure.

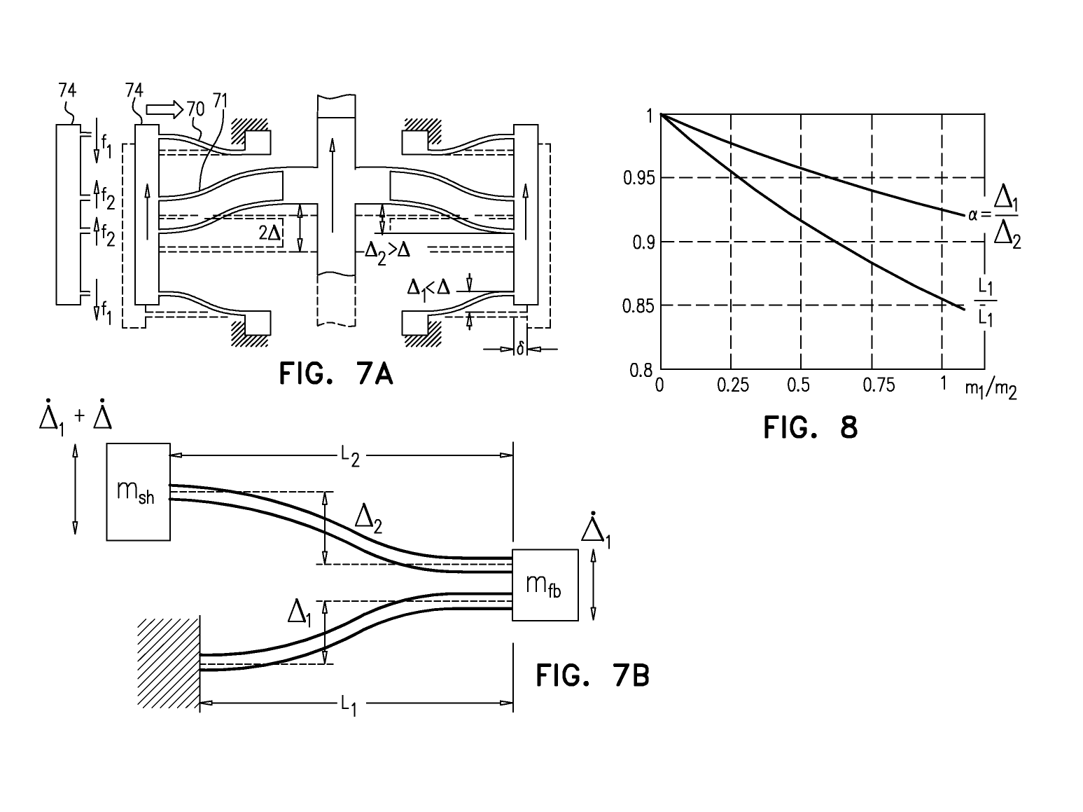

Reference is now made to FIGS. 7A and 7B, which schematically illustrates an example of this novel structure of a folded-beam suspension with flexure beams of different lengths 70, 71. FIG. 7A, similar to what is shown in FIG. 3C, shows the complete suspension system, with the deformed shape in full lines, and a dashed outline of the undeformed shape. To achieve harmonic motion of the flying-bars, the restoring forces f₁ induced by the anchored flexures are larger than those f₂ of the shuttle flexures, i.e. f₁>f₂. This is achieved by shortening the length of the anchored flexures 70. This results in a nonzero resultant force on the flying-bars 74, which is necessary for their acceleration. Due to the symmetries of the full suspension, a simplified model is shown in FIG. 7B, which shows only a quarter of the system, to simplify the analysis of this configuration, as follows.

For this novel configuration, the effective shortening 6 expressed in equation (2) may be calculated. If the effective shortening of the now two different length beams is to be equal, then we may add to equation (3) the requirement that Δ₁²/L₁=Δ₂²/L₂, or equivalently

$$\frac{{L}_{1}}{{L}_{2}} = \frac{{Δ}_{1}^{2}}{{Δ}_{2}^{2}} = {α}^{2} \qquad ( 9 )$$

Since k₁=12EI/L₁³ and k₂=12EI/L₂³ as observed from equation (1), it follows that

$$\frac{{k}_{1}}{{k}_{2}} = \frac{1}{{α}^{6}} \qquad ( 10 )$$

Substituting this into equations (5) and (6) yields

$$\begin{matrix}\frac{{m}_{1}}{{m}_{2}} = ( 1 + α ) ( \frac{1}{{α}^{6}} - \frac{1}{α} ) & ( 11 ) \\ {ω}^{2} = \frac{{k}_{2}}{{m}_{2 }} \frac{1}{1 + α} = \frac{{k}_{1}}{{m}_{1}} ( 1 - {α}^{5} ) & ( 12 )\end{matrix}$$

Reference is now made to FIG. 8 which is a graph showing the relation between the parameters of the dynamically-balanced folded-beam suspension. In FIG. 8, there is presented the relative motion ratio α, and the optimal ratio of beam lengths, L₁/L₂, as a function of the ratio between the masses of the flying-bars and shuttle, m₁/m₂. A suspension with the correctly selected ratio of beam lengths will yield a dynamically-balanced linear system with no strain stiffening induced in the flexure beams, and therefore no nonlinear effects of this type. At its natural frequency, such a dynamically-balanced system will vibrate at the correct motion ratio—regardless of the motion amplitudes. This motion ratio will ensure that no strain stiffening will be induced into the flexure beams, and that no non-linear effects will therefore be encountered.

To simulate the expected dynamic response of such a folded beam suspension, a system having the same base dimensions as those of the device described hereinabove in connection with FIG. 1 was fabricated, with the following parameters: L₂=600 μm, h=3 μm and t=25 μm E=170 [GPa]).

Firstly, a system in which m₁=m₂ is considered. For the prior art standard folded beam suspension (STD), insertion of these values into equation (7) predicts that α_{STD}=(1+\sqrt{5})/2=1.618.

For m₁=m₂ the dynamically-balanced (DB) model given by equation (11) yields that α_{DB}=0.9245, and from equation (9) it follows that L₁=0.8548 L₂, as can be seen from the graphs of FIG. 8 for m₁/m₂=1.

For both the standard system and the dynamically-balanced design, the static force applied to the shuttle and to the flying-bar can be simulated for any set of displacements (Δ₁,Δ₂) using the ANSYS 14.5 program. In this simulation, beam elements and a nonlinear solver (i.e. large deformations) should be used. The dynamic response of the system can be simulated using these forces, and time integration implemented in a MATLAB code.

Two types of simulations are now shown: free vibrations of an undamped system and forced vibrations of a damped system. The aim of these simulations is to demonstrate that the dynamic response of the standard folded-beam suspension is nonlinear, and that the new dynamically-balanced suspension of the present application solves this problem. This would indicate that the nonlinearity in small vibrations is indeed due to inertial effects.

In these simulations, the system is statically displaced to an eigenmode, and then released to vibrate without any damping. The initial static displacement is Δ₁=Δₛₕα/(1+α) and Δ₂=Δₛₕ/(1+α) such that the total shuttle displacement is Δₛₕ=Δ₁+Δ₂, where α=α_{STD} for the standard system, and α=α_{DB} for the new dynamically-balanced system of the present disclosure.

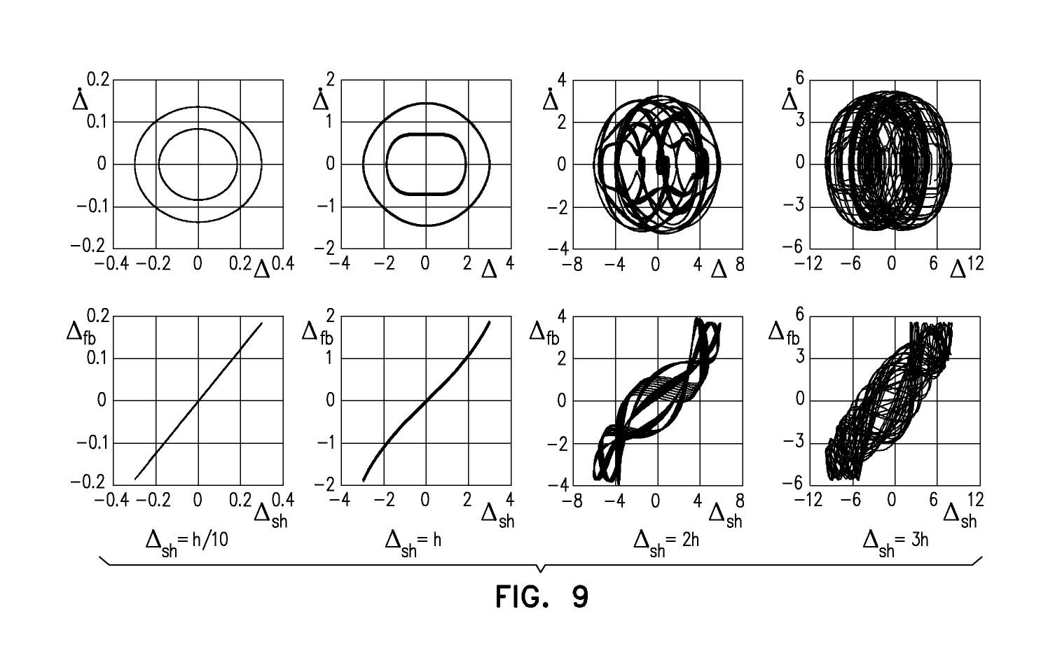

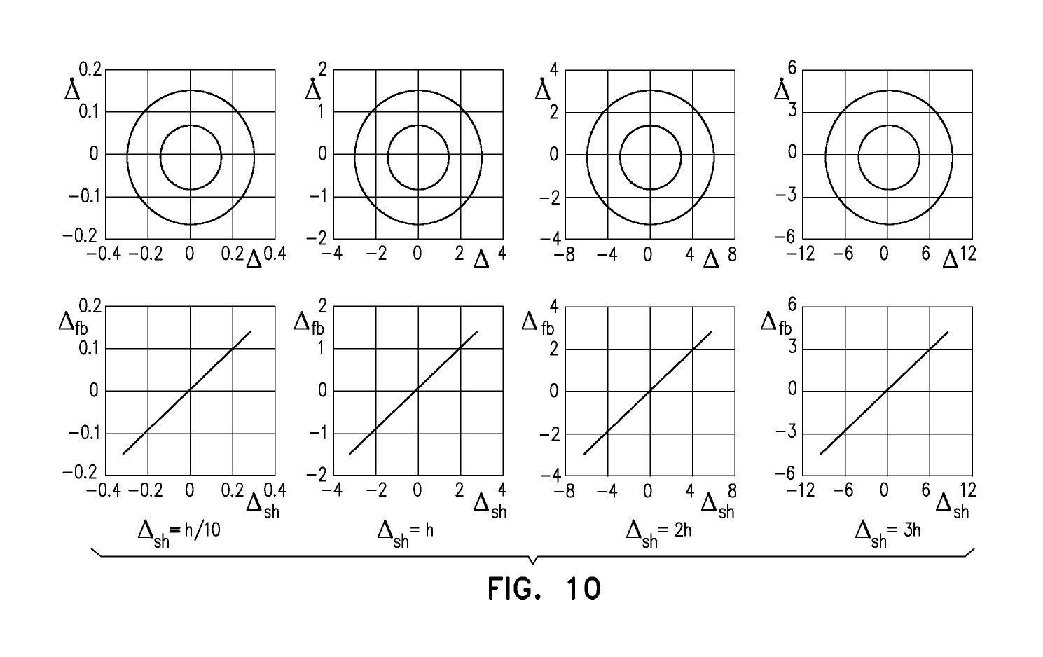

Reference is now made to FIG. 9, which shows state-space representations and Lissajous curves of the standard folded-beam suspension with m₁/m₂=1. The plots relate to 20˜25 undamped, free vibration cycles, beginning at a static state with α_{STD}=1.618 and different values of the initial shuttle displacement Δₛₕ and for different values of the beam width h. The top row of plots is a series of state-space representations of displacement Δ and velocity \dot{Δ}, being the horizontal and vertical axes respectively. In these plots, the external and internal loops relate to the motion of the shuttle and of the flying-bar, respectively. The bottom plots are Lissajous curves relating the position of the shuttle Δₛₕ (horizontal axis) and that of the flying-bar Δ_{fb} (vertical axis).

As is observed in the leftmost column of drawings for a small shuttle motion amplitude Δₛₕ h/10, the response is a single harmonic, indicating that the system behaves as a perfect linear spring. When the shuttle motion amplitude is comparable to the beam width (i.e. Δ₁≈h/2, Δ₂≈h/2), it is clear that the system response is already affected by nonlinearity. Nonlinearity is increased when the shuttle motion amplitude Δₛₕ is increased. It is noted that for Δₛₕ=3h, the shuttle motion is still a mere 9 μm, which is very small relative to the beam length of L=600 μm, and yet it is evident that the response is significantly nonlinear.

Reference is now made to FIG. 10, which presents the resulting response during the first 20˜25 vibration cycles, for the novel dynamically-balanced suspension of the present disclosure with different values of Δₛₕ, for different values of the beam width h. In this system L₁=0.8548 L₂, which is compatible with the mass ratio m₁/m₂=1. It is evident that the system is linear regardless of the motion amplitude Δₛₕ. The contrast with the dynamic response of the standard prior art folded-beam suspension of FIG. 9 is very clear. The dynamically-balanced suspension maintains the motion amplitude ratio of α_{DB}=0.9245, regardless of the amplitude of the cyclic motion.

Simulations are now performed in which the shuttle and flying-bar are each subjected to a linear damping force, proportional to their respective velocities. The same damping coefficient is arbitrarily used for both masses. In these simulations, the shuttle is excited by a harmonic force fₛₕ=f₀ sin(ωt) and the time response is integrated over a sufficiently long time, until the transient response has decayed and a steady periodic response achieved. Then, the motion amplitude of the shuttle is recorded. This motion amplitude is simulated for a wide range of frequencies around the first mode resonance frequency. These frequency sweeps are repeated for different levels of excitation force f₀, to ensure different values of peak motion amplitude at resonance. To this end, a damping coefficient must be chosen, and in order to simplify matters, a damping coefficient c=\sqrt{k₁m_{fb}}/100 is used, such that if the system were constructed only from the first beam and the flying-bar, the resulting quality factor would be Q=100.

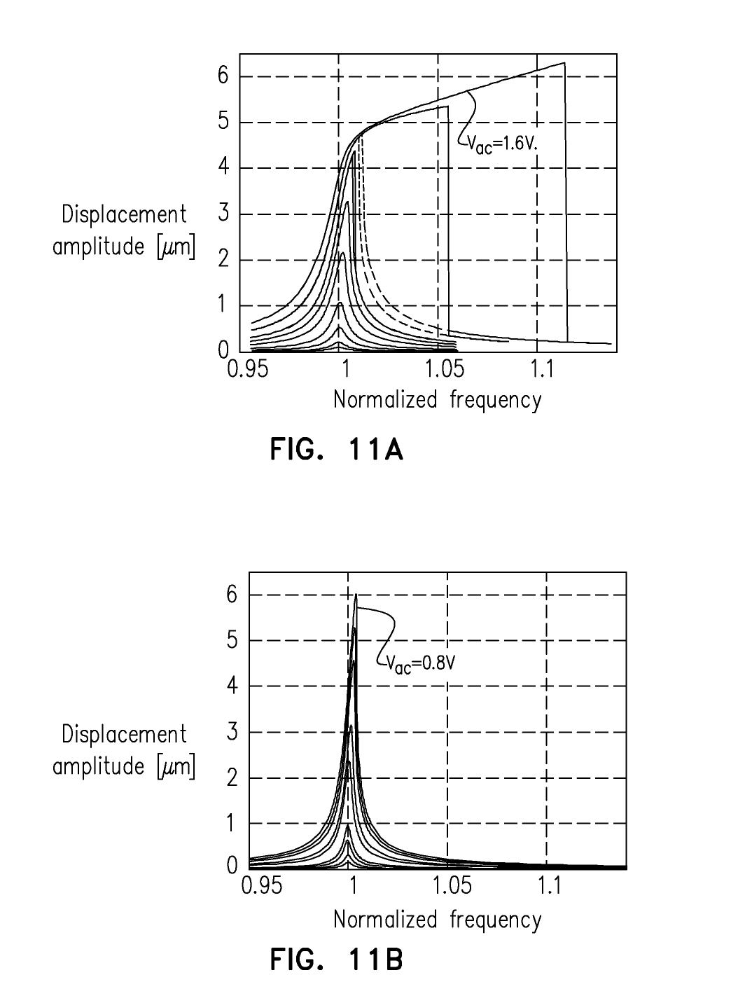

Reference is now made to FIGS. 11A and 11B, which present measured displacement amplitudes for frequency sweeps, with different AC voltage settings for two example folded beam suspensions. The results of the device with the conventional prior art folded beam suspension and those of the dynamically-balanced folded beam suspension of the present disclosure are presented in FIG. 11A and FIG. 11B respectively. For comparison, the frequencies in each figure are normalized by the natural frequency of the related device as measured for the smallest Vac.

The lowest amplitude drive for both of the sets of plots shown in FIGS. 11A and 11B is for Vac=0.02V RMS, while the largest amplitude drive in FIG. 11A is for Vac=1.6V RMS, and 0.8V RMS for FIG. 11B.

The frequency sweeps of the standard device, FIG. 11A, exhibit considerable nonlinear stiffening, which increases with increasing Vac. Since the solution bifurcates into two branches, simulations are performed with both increasing (solid) and decreasing (dotted) frequency sweeps. It is clear that when motion amplitude increases above 1.5 μm (i.e. half of the width h of the 3 μm flexure beams), the nonlinear stiffening becomes more apparent. In fact, the nonlinear stiffening completely dominates the response for displacement amplitudes above 4 μm. For a displacement amplitude of 6 μm, the frequency of peak response is even 11% above the natural frequency of the standard device. It can be shown that if the quality factor is higher, and hence the resonance peak is sharper, then the nonlinearity becomes observed at even smaller motion amplitudes. All of this clearly demonstrates that the nonlinear response of conventional prior art folded-beam suspensions is not due to large motion amplitudes. Moreover, in these simulations mechanical forces that have no nonlinear effects are used, so it is clear that the nonlinear response of the suspension is not due to possible nonlinearity of electrostatic forces. The simulated response in FIG. 11A closely resembles the measurements presented in FIG. 2, showing the same nonlinear characteristics of the conventional prior art folded-beam suspension.

In contrast, the device with the novel dynamically-balanced folded-beam suspension of the present disclosure, as shown in FIG. 11B, shows only marginal stiffening. Stiffening is marginal even for a displacement amplitude of as much as 6 μm, where the frequency of peak response is only 0.4% higher than the natural frequency. Though the balanced device shows marginal stiffening it does not exhibit any nonlinear bifurcation (pitchfork), which is so dominant in the prior art device of FIG. 11A. The results shown in FIG. 11B and the simulated undamped responses observed in FIG. 10, clearly demonstrate that the novel suspension configuration described in this disclosure, is indeed dynamically-balanced.

In FIGS. 11A and 11B, a number of curves are plotted for increasing amplitudes of the AC drive signal. Due to the nonlinear response of the standard device, it requires higher voltages to achieve similar displacement amplitudes, the drive voltages shown to provide a 6 μm displacement amplitude being about twice as high in FIG. 11A as those of FIG. 11B. This comparison is biased because in the example suspensions used for these measurements, the quality-factor measured for the balanced device of FIG. 11B (Q_{DB}≈270) is somewhat higher than the quality-factor measured for the device with the standard prior art suspension of FIG. 11A (Q_{STD}≈160). The difference in quality-factor is predominantly due to the difference in the back-side openings in the two types of devices.

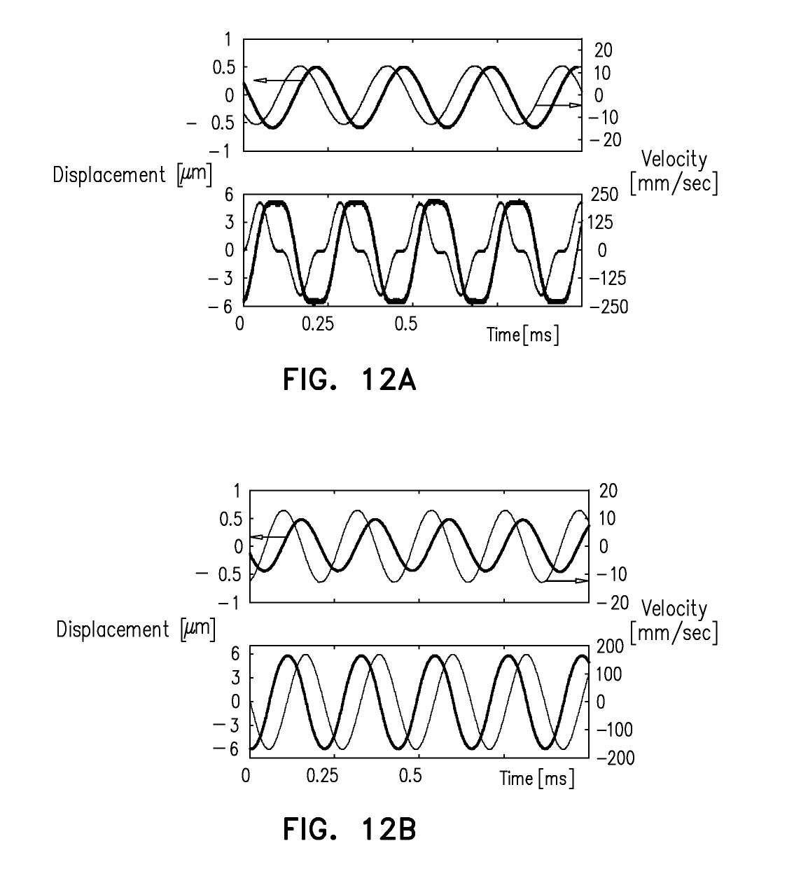

Reference is now made to FIGS. 12A and 12B, which present measured time responses of the velocity and the displacement for small (upper graphs, 0.5 μm) and large (lower graphs, 6 μm) motions. FIG. 12A shows the results for a conventional prior art device with a standard folded-beam suspension, while FIG. 12B shows the results for a device of the present disclosure, with the dynamically-balanced folded-beam suspension. The displacement curves, relating to the left hand ordinates, are drawn as full lines, while the velocity curves, relating to the right hand ordinates, are drawn as dashed lines.

It is evident that the prior art suspension device exhibits a nonlinear response for large motion amplitudes of 6 μm, whereas the dynamically-balanced suspension device of the present application, maintains its linear response up to such large amplitude motions.

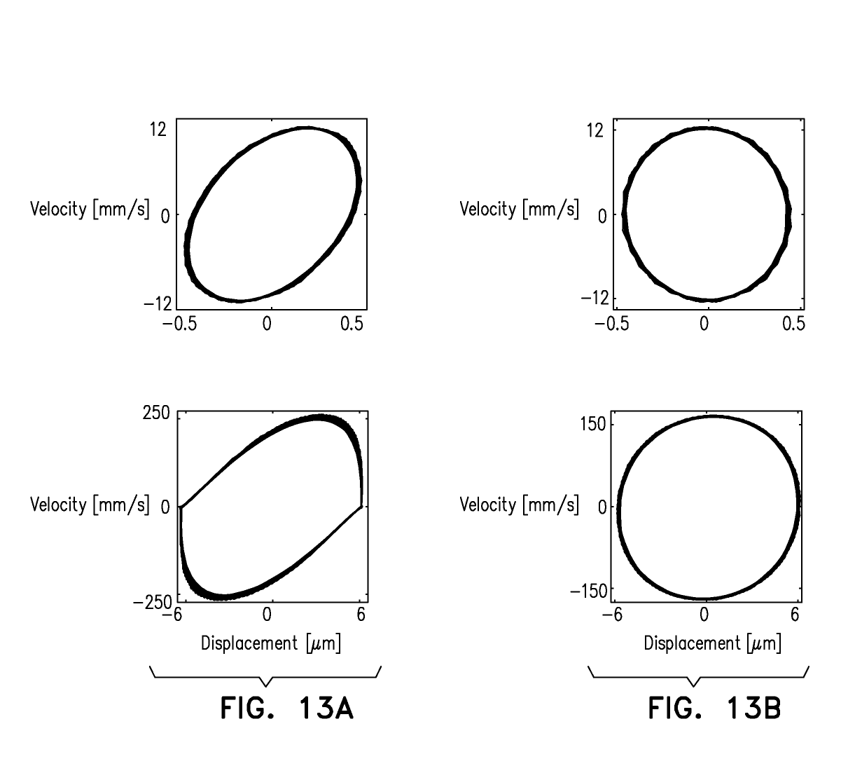

Reference is now made to FIGS. 13A and 13B, which present measured state-space curves at frequency of peak response, for small ˜0.5μ motion amplitudes in the top row, and for large (˜6 μm) motion amplitudes in the bottom row. FIG. 13A shows the state-space curves for the conventional prior art folded-beam suspension. It is evident that in large motions, the response exhibits significant nonlinear effects. FIG. 13B for the novel dynamically-balanced folded-beam suspension device of the present disclosure, shows that the suspension maintains its linear response even for large displacements.

It is therefore concluded that the nonlinear dynamic response emanates from inertial effects which induce strain stiffening, and is a fundamental characteristic of the folded-beam suspension. The dynamic response can be made linear by use of the novel configuration described in this disclosure, in which the flexure beams have predetermined different lengths.

In the dynamically-balanced folded-beam suspension the resonance amplitude is bounded by damping, as can be expected in a linear system. Since the dynamic response of the standard folded-beam suspension is nonlinear, its motion amplitude is bounded by nonlinear stiffening (e.g. Duffing response), and not by damping. In fact, in the simulated damped dynamic response, the standard prior art suspension may achieve only 60% of the displacement achieved by the dynamically-balanced system, and to get to this 60%, a positive frequency sweep has to be used. If the standard suspension is excited at the frequency where motion is maximized, only small amplitude would be achieved. In the case of the standard suspension, if the resonance frequency for a small excitation force is identified, and that force is then increased, the maximal motion would be capped by nonlinearity.

By considering the dynamically-balanced suspension it has been shown that the nonlinear response of the standard folded-beam suspension is due to inertial effects. In actual comb-drive actuators that are supported by folded-beam suspensions, the mass of the flying-bars is usually very small relative to the mass of the shuttle. But more importantly, the mass of the flexure beams is often larger than the mass of the flying-bars. Therefore, more rigorous development of a dynamically-balanced folded-beam suspension requires consideration of the beam inertia in the analysis. This additional effect can be considered, and mathematical formalism developed, which enables the calculations of the optimal lengths of the different flexure beams also taking into account the inertia of the flexure beams. These calculations are now provided as an additional improvement in the model of the dynamically balanced folded-beam suspensions of the present disclosure. There may be some overlap of the sections of the material with that of the above described mathematical formulation, without taking into account the inertia of the flexure beams, but the additional formalism is now presented in its entirety.

A more rigorous design of the dynamically-balanced suspensions of the present disclosure should account for the inertia of the flexure beams. The continued disclosure hereinbelow describes mathematical formalism for inclusion of the inertia of the flexure beams in the analysis of the dynamic response of folded-beam suspensions. Based on this analysis, the improved methodology for designing dynamically-balanced suspension is presented.

It is constructive to begin the analysis by considering the dynamic response of a single clamped-flat beam. This section focuses on the dynamic response of a beam which does not vibrate at its natural frequency.

Dynamic Deformation Mode Reference is now made to FIG. 14, which illustrates schematically the dynamic deformation mode of a clamped-flat Euler Bernoulli beam. The beam of length L₁ is clamped at one edge (x=0), and its slope is constrained at the other edge. The equation of motion of the beam is given by:

$$ρ A \frac{{\partial }^{2} y}{\partial {t}^{2}} = - {E}^{*} I \frac{{\partial }^{4} y}{\partial {x}^{4}} \qquad ( 13 )$$

Here p is the density of the beam, A=h t is the cross-section area, E* is the effective bending modulus, and I= 1/12th³ is the second moment of the rectangular cross-section, where h is the beam width and t is the beam thickness (i.e. the device layer thickness). Because the beam is wide, t>>h, E*=E/(1−v²) where E is the Young modulus and v is the Poisson ratio, as shown in the article entitled “Non-linear dynamics of spring softening and hardening in folded MEMS comb drive resonators” by A. M. Elsurafa et al, published in Journal of Microelectromechanical Systems, Vol. 20, pp. 943-958 (2011).

Using the non-dimensional variables

$$\tilde{x} = \frac{x}{{L}_{1}} , \tilde{t} = \sqrt{\frac{{E}^{*} I}{ρ {AL}_{1}^{4}}} t , \tilde{ω} = ω \sqrt{\frac{ρ {AL}_{1}^{4}}{{E}^{*} I}} \qquad ( 14 )$$

the equation of motion may be rewritten as

$$\frac{{\partial }^{2} y}{\partial {\tilde{t}}^{2}} = - \frac{{\partial }^{4} y}{\partial {\tilde{x}}^{4}} \qquad ( 15 )$$

Using separation of variables, a solution of the form y(\tilde{t},\tilde{x})=T(\tilde{t})Y(\tilde{x}) may be considered. The general solution of Eq. (15) is given by

T=sin(\tilde{ω}\tilde{t}) where \tilde{ω}=λ² (16)

Y=A sin(λ\tilde{x})+B cos(λ\tilde{x})+C sin h(λ\tilde{x})+D cos h(λ\tilde{x}) (17)

The boundary conditions of the problem are

@x=0Y=0,Y′=0 (18)

@x=1Y′″=0 OR λ²=Ω,Y′=0 (19)

It is emphasized that if the constraint λ²=Ω is implemented rather than the boundary condition Y′″=0, then there are only three boundary conditions and one constraint.

Implementing the boundary conditions (18) yields

Y(0)=B+D=0 [symbol] D=−B

Y′(0)=Aλ+Cλ=0 [symbol] C=−A (20)

and implementing the second boundary condition in (19) (i.e. Y′_{(\tilde{x}=1)}=0) yields

$$B = A \frac{cos ( λ ) - cosh ( λ )}{sin ( λ ) + sinh ( λ )} \qquad ( 21 )$$

The spatial solution Y(x) may be then renormalized such that Y(1)=Δ₁

$$Y = {Δ}_{1} \frac{\begin{matrix}( sin ( λ ) + sinh ( λ ) ) ( sin ( λ \tilde{x} ) - sinh ( λ \tilde{x} ) ) + \\ ( cos ( λ ) - cosh ( λ ) ) ( cos ( λ \tilde{x} ) - cosh ( λ \tilde{x} ) )\end{matrix}}{2 ( 1 - cos ( λ ) cosh ( λ ) )} \qquad ( 22 )$$

The free vibration solution, for which the boundary condition Y′″(1)=0 must hold, is given by

$${Y}^{′′′} ( 1 ) = 2 {Δ}_{1} \frac{cos ( λ ) sinh ( λ ) + sin ( λ ) cosh ( λ )}{sin ( λ ) + sinh ( λ )} = 0 \qquad ( 23 )$$

This transcendental equation may be solved for the first eigen-frequency Λ=2.365. The analysis presented in this sub-section is well known. However, since the clamped-flat beam is part of a larger system, its response should be studied when the entire system is in resonance. This means that the individual beam would harmonically vibrate at a sub-resonance frequency. It follows that the edge conditions must include reactive forces which are important for the analysis. In the following sub-section, this uncommon consideration is used to quantify the edge forces in a sub-resonance cyclic response.

### Edge-Forces

If the far edge, x₁=L₁, is constrained to vibrate harmonically at frequency \tilde{ω}=λ²≠Λ², which is different from the first eigen-frequency of the clamped-flat beam, then the necessary force at the constrained far edge is

$${f}_{1 fb} = - {E}^{*} I \frac{{d}^{3} Y}{d {x}^{3}} {\vert}_{x = {L}_{1}} = {λ}^{3} \frac{{E}^{*} I {Δ}_{1}}{{L}_{1}^{3}} \frac{sin ( λ ) cosh ( λ ) + cos ( λ ) sinh ( λ )}{1 - cos ( λ ) cosh ( λ )} \qquad ( 24 )$$

The factor 1/L₁³ appears because the third derivative is taken with respect to x (not \tilde{x}). This reaction force is marked by f_{1fb} because the force interaction between beam 1 and the flying-bar at this point will later be considered. Since the right-hand-side of equation (24) is proportional to the expression used in equation (24), it is not surprising that for λ=Λ the edge force indeed vanishes f_{1fb}(λ=Λ)=0.

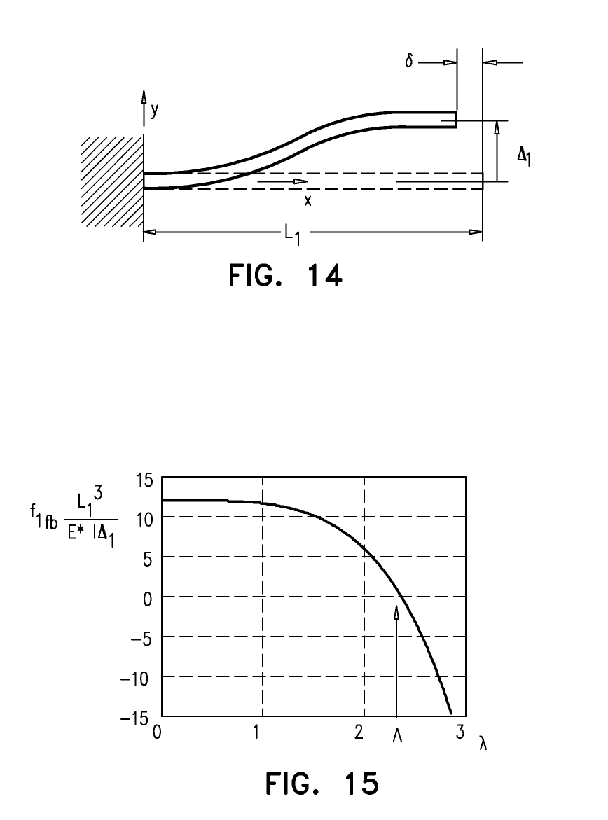

Reference is now made to FIG. 15, which presents the edge force which is necessary for vibrating the clamped-flat beam, at any arbitrary frequency \tilde{ω}=λ². For frequencies below the first natural frequency λ<Λ, the necessary edge force is positive (i.e. the force is in the direction of motion), and that for frequencies slightly above the first natural frequency the force is negative.

Finally, for very low frequencies (i.e. λ→0) the solution converges to

Y(\tilde{x})=Δ₁(3\tilde{x}²−2\tilde{x}³) (25)

As may be expected, this is the static deflection of a clamped-flat Euler-Bernoulli beam with Y(1)=Δ₁. In this case the edge force converges to f_{R}=12E*Δ₁/L₁³, which is the classic solution for a clamped-flat Euler-Bernoulli beam.

### Effective Shortening

Due to the dynamic deformation of the vibrating beam, its far edge retracts towards the clamped edge, as discussed hereinabove, and is marked by δ in FIG. 14. It may be shown that this effective shortening may be expressed as a series of Δ, with leading term given by

$$δ = {c}_{1} \frac{{Δ}^{2}}{L} + O ( {Δ}^{4} / {L}^{3} ) \qquad ( 26 )$$

As long as the edge deflection is sufficiently smaller than the beam length (i.e. Δ<L), the higher order terms may be neglected. The parameter c₁ depends on the frequency of vibration, which determines the shape of the mode, but in this analysis, c₁ is considered as a constant. This assumption will be discussed below.

The dynamic response of the folded-beam suspension shown hereinabove in FIGS. 7A and 7B is now undertaken, according to the current mathematical formalism.

### Dynamic Deformation Mode

The dynamic response of beam 1 which connects the flying-bar to the anchor was analyzed in the previous section hereinabove. As for beam 2 which connects the shuttle to the flying-bar, the normalized equation of motion is the same as in Equation (15) and the general solution Y₂ has the same form as in Equations (16) and (17). However, for this second beam, the relevant boundary conditions are different and are given by

@\tilde{x}=0Y₂=Δ₁,Y₂′=0 (27)

@\tilde{x}=1Y₂=Δ₁+Δ₂,Y₂′=0 (28)

It seems that since there are now four boundary conditions, the problem is well-posed. However, this is not so because the amplitude ratio Δ₁/Δ₂ is a solution of a problem, which will be discussed in the discussion on Effective Shortening below.

Implementing the boundary conditions (27) and (28), on the spatial solution (17), yields the system

$$( \begin{matrix}0 & 1 & 0 & 1 \\ 1 & 0 & 1 & 0 \\ sin ( λ ) & cos ( λ ) & sinh ( λ ) & cosh ( λ ) \\ cos ( λ ) & - sin ( λ ) & cosh ( λ ) & sinh ( λ )\end{matrix} ) ( \begin{matrix}A \\ B \\ C \\ D\end{matrix} ) = ( \begin{matrix}{Δ}_{1} \\ 0 \\ {Δ}_{1} + {Δ}_{2} \\ 0\end{matrix} ) \qquad ( 29 )$$

The solution of this system is

$$A = - C = \frac{\begin{matrix}( {Δ}_{1} + {Δ}_{2} ) ( sin ( λ ) + sinh ( λ ) ) - \\ {Δ}_{1} ( sin ( λ ) cosh ( λ ) + cos ( λ ) sinh ( λ ) )\end{matrix}}{2 ( 1 - cos ( λ ) cosh ( λ ) )} \\ B = \frac{\begin{matrix}( {Δ}_{1} + {Δ}_{2} ) ( cos ( λ ) - cosh ( λ ) ) - \\ {Δ}_{1} ( cos ( λ ) cosh ( λ ) - sin ( λ ) sinh ( λ ) - 1 )\end{matrix}}{2 ( 1 - cos ( λ ) cosh ( λ ) )} \\ C = - \frac{\begin{matrix}( {Δ}_{1} + {Δ}_{2} ) ( cos ( λ ) - cosh ( λ ) ) + \\ {Δ}_{1} ( sin ( λ ) sinh ( λ ) + cos ( λ ) cosh ( λ ) - 1 )\end{matrix}}{2 ( 1 - cos ( λ ) cosh ( λ ) )} \qquad ( 30 )$$

So, the mode of the deformation is given by substituting the constants from (30) into (17).

### Edge Forces

If the system vibrates harmonically at a frequency \tilde{ω}=λ², then the necessary force at the far edge (i.e. at the connection with the shuttle) is given by

$$\begin{matrix}{{f}_{2 sh} = - {E}^{*} I \frac{{d}^{3} {Y}_{2}}{d {x}^{3}} \vert}_{x = {L}_{2}} \\ = {λ}^{3} \frac{{E}^{*} I}{{L}_{2}^{3}} \frac{\begin{matrix}( {Δ}_{1} + {Δ}_{2} ) ( sin ( λ ) cosh ( λ ) + cos ( λ ) sinh ( λ ) ) - \\ {Δ}_{1} ( sin ( λ ) + sinh ( λ ) )\end{matrix}}{1 - cos ( λ ) cosh ( λ )}\end{matrix} \qquad ( 31 )$$

and the necessary force at the near edge (i.e. at the connection with the flying-bar) is given by

$$\begin{matrix}{{f}_{2 sh} = - {E}^{*} I \frac{{d}^{3} {Y}_{2}}{d {x}^{3}} \vert}_{x = 0} \\ = - {λ}^{3} \frac{{E}^{*} I}{{L}_{2}^{3}} \frac{\begin{matrix}( {Δ}_{1} + {Δ}_{2} ) ( sin ( λ ) + sinh ( λ ) ) - \\ {Δ}_{1} ( sin ( λ ) cosh ( λ ) + cos ( λ ) sinh ( λ ) )\end{matrix}}{1 - cos ( λ ) cosh ( λ )}\end{matrix} \qquad ( 32 )$$

As in (24) (24), the factor 1/L₂³ appears because the third derivative is taken with respect to x (not \tilde{x}). But here is a subtle point which has to be carefully attended to: from (26) and (28), it follows that the definition of λ used in the section on the Dynamics of the Flat Clamped Beam above, is based on the beam length L₁. But now, it is necessary to consider two beams with different lengths. So it is necessary to define

$$λ = {{ω}^{\frac{1}{2}} ( ρ A / {E}^{*} I )}^{\frac{1}{4}} {L}_{2} ,$$

such that (24) must be rewritten in the form

$$\begin{matrix}{f}_{1 fb} = - {E}^{*} I \frac{{d}^{3} Y}{d {x}^{3}} {\vert}_{x = {L}_{1}} = {λ}^{3} \frac{{E}^{*} I {Δ}_{1}}{{L}_{1}^{3}} \frac{sin ( λ ) cosh ( λ ) + cos ( λ ) sinh ( λ )}{1 - cos ( λ ) cosh ( λ )} \\ where & ( 33 ) \\ {λ}_{1} = {{ω}^{\frac{1}{2}} ( \frac{ρ A}{{E}^{*} I} )}^{\frac{1}{4}} {L}_{1} = λ \frac{{L}_{1}}{{L}_{2}} & ( 34 )\end{matrix}$$

### Motion Equations

It follows that the motions of the shuttle and of the flying-bar, are governed by the set of equations

$$- {λ}^{4} \frac{{E}^{*} I}{ρ {AL}_{2}^{4}} {m}_{sh} ( {Δ}_{1} + {Δ}_{2} ) = - {f}_{2 sh} \\ - {λ}^{4} \frac{{E}^{*} I}{ρ {AL}_{2}^{4}} {m}_{fb} {Δ}_{1} = - {f}_{2 fb} - {f}_{1 fb} \qquad ( 35 )$$

The factor E*I/ρAL₂⁴ appears on the left hand side of these equations because the second time-derivative with respect to t (not \tilde{t}) is taken. In these equations, the variables E*, I, ρ, A, L₂, m_{fb} and mₛₕ are all known.

### Effective Shortening

Due to the dynamic deformation of the vibrating beams, their far edge (connected to the flying-bar) retracts, as discussed above. The deformation modes of the two beams are not the same, and therefore the effective shortening of each may be described by (26), but with a unique constant for each of the two beams. To simplify the analysis, it is assumed that the shape-mode of the two beams is sufficiently similar (i.e. their normalized deformation modes are proportional), and that the effective shortening of both is given by equation (26) with the same constant. This assumption is verified by numerical simulations, to be valid for the devices shown above. It therefore follows that if both beams should have an identical effective shortening, such that no axial stress is induced, it is necessary to satisfy the relationship Δ₁²/L₁=Δ₂²/L₂, or alternatively, as already noted earlier in this disclosure in equation (9), for the derivation made without taking into account the inertia of the flexure beams:

$$\frac{{L}_{1}}{{L}_{2 }} = \frac{{Δ}_{1}^{2}}{{Δ}_{2}^{2}} = {α}^{2} \qquad ( 36 )$$

### Solution

For a system with a standard prior art folded-beam suspension with equal length beams, L₁=L₂, and the set of equations (35) may be solved for the first eigenfrequency Λ_{STD} and the related eigenvector α_{STD}=Δ₁/Δ₂. However, this system fails to consider membrane stiffening. It may therefore be expected that such prior art suspensions will suffer nonlinear effects in their cyclic dynamic response for large motion amplitudes.

Alternatively, for a system with the novel dynamically-balanced suspensions of the present application, equations (35) may be solved together with the constraint (36). These three equations will yield the first eigenfrequency Λ_{DB}, the eigenvector characteristic α_{DB}=Δ₁/Δ₂ and the beam lengths ratio L₁/L₂=α_{DB}². For this dynamically-balanced suspension, it is expected that membrane stiffening and the related nonlinear response will be completely avoided.

### EXAMPLES

In order to verify the above mathematical calculations, test devices were fabricated using the SOIMUMPs technology described at the beginning of this disclosure. The test devices were electrostatic comb-drive resonators suspended on folded-beam suspensions. The devices were fabricated in a (100) single crystalline silicon layer, with flexure beams oriented in the (110) direction. Two types of test devices were fabricated: one device with a standard prior art folded-beam suspension with beams of equal length, and the other with a dynamically-balanced suspension of the present application, with a shortened anchored beam. The devices were designed with an arbitrary mass ratio of mₛₕ=m_{fb}.

The flexure beams were designed to be h=3 μm wide, 1=25 μm thick, and L₂=600 μm long, except for the shorter beam in the dynamically-balanced suspension. For these devices the shorter beam is designed to be L₁=497 μm long. This length was determined by solving equations (35) and (36), with the appropriate masses of shuttle and flying bars, material properties, and the geometric parameters h, t, and L₂ detailed above.

The natural frequency of the standard device was designed to be 5090 Hz, but in one example fabricated, was measured to be 3870 Hz. It was noted that the fabricated beams were over-etched in this measured sample, and their width was measured to be h≈2.5 [μm]. Accommodating for this actual beam width, the predicted natural frequency becomes 3980 Hz.

The natural frequency of a novel dynamically-balanced device fabricated was designed to be 6000 Hz, but was measured to be 4586 Hz. If accommodation is made for a beam width of h≈2.5 [μm], the predicted natural frequency would become 4650 Hz.

It is interesting to note that if accommodation were made for the narrower beam width of h≈2.5 [μm], the shorter beam would have been predicted to be L₁=498 μm, which is close to the value predicted for the designed width h=3 μm. This closeness is due to the fact that the mass of the flexure beams is relatively small relative to the mass of the flying-bar, which is the dominant factor.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A folded beam suspension resonator comprising:
a shuttle suspended by a suspension such that its motion is regulated by the elastic characteristics of said suspension;
a pair of flying bars, one disposed on each side of said shuttle, each flying bar connected to said shuttle by a first pair of flexure beams, and being connected to anchor points by a second pair of flexure beams, the length of each of said second pair of flexure beams being shorter than the length of each of said first pair of flexure beams;
wherein the lengths of said flexure beams in said first and second pairs of flexure beams are selected such that no internal axial stresses are induced in said flexure beams when said resonator is undergoing harmonic motion.

2. A folded beam suspension resonator according to claim 1, wherein said lack of internal axial stress is achieved by selecting the lengths of said flexure beams such that the axial contractions of said first pair of flexure beams are equal to the axial contractions of said second pair of flexure beams.

3. A folded beam suspension resonator according to claim 1, wherein said harmonic motion has a linear response, such that the stiffness of said suspension is independent of the amplitude of said harmonic motion.

4. A folded beam suspension resonator according to claim 3, wherein said linear response is maintained when said shuttle has an amplitude of motion of more than the width of said flexure beams, said width being defined as being in the plane of motion of said resonator.

5. A folded beam suspension resonator according to claim 1, wherein said lack of internal axial stresses arises from the elimination of the resultant compression and resultant tension strain stiffening forces within said first and second pairs of flexure beams, due to said harmonic motion.

6. A folded beam suspension resonator according to claim 1, wherein said folded beam suspension is fabricated on a substrate, and the material of said suspension is essentially the same as that of said substrate.

7. A method of generating harmonic motion having a linear response in a folded beam suspension resonator, said folded beam suspension comprising a shuttle connected to a pair of flying bars by second pairs of flexure beams, each of said flying bars being connected to anchor points by a first pair of flexure beams, said method comprising selecting different lengths L₁ and L₂ for the flexure beams of said first and second pairs of flexure beams, the ratio between lengths L₁ and L₂ being unknown, wherein said ratio can be determined by:
generating the equations of motion of said shuttle and of each of said flying bars in terms of the known geometrical and material parameters of the elements of said resonator, wherein the amplitude Δ₁ of the edge deflection of a flexure beam of said first pair of flexure beams, generated by motion of a flying bar relative to said anchor, and the amplitude Δ₂ of the edge deflection of a flexure beam of said second pair of flexure beams, generated by motion of said shuttle relative to a flying bar, and the fundamental resonant frequency of said resonator is unknown;
determining the axial contraction δ₁ and δ₂ of each of said pairs of flexure beams; and
applying to said equations of motion the additional constraint equation that said axial contractions δ₁ and δ₂ are identical, such that said resonator has a linear response.

8. A method according to claim 7 wherein said resonator has linear response when said shuttle has an amplitude of motion of more than the width of said flexure beams, said width being defined as being in the plane of motion of said resonator.

9. A method according to claim 7 wherein said folded beam suspension is fabricated on a substrate, and the material of said suspension is essentially the same as that of said substrate.
